(19) United States
(12) Patent Application Publication
(10) Pub. No.: US 2010/0047376 A1
(43) Pub. Date: Feb. 25, 2010

(54) NERVE CUFF INJECTION MOLD AND METHOD OF MAKING A NERVE CUFF

(76) Inventors: Marc-Olivier Imbeau, St. Augustin-de- Desmaures (CA); Martin Richard, Thetford Mines (CA); Jean-Martin Vallieres, Cap-Rouge (CA)

Correspondence Address: POLSINELLI SHUGHART PC, 700 W. 47TH STREET, SUITE 1000, KANSAS CITY, MO, 64112-1802, US

(21) Appl. No.: 12/301,582

(22) PCT Filed: Aug. 29, 2007
(86) PCT No.: PCT/CA2007/000526

§ 371 Date: Oct. 30, 2009

Related U.S. Application Data
(60) Provisional application No. 60/840,698, filed on Aug. 29, 2006.

(51) Int. Cl. B29C 45/14

(52) U.S. Cl. 425/116; 425/542

(57) ABSTRACT

A mold for a nerve cuff having a first molding body defining a first molding cavity and a second molding body defining second molding cavity. The first and second molding bodies being mountable to one another thereby providing for the first and second molding cavities to interface. When interfacing the first and second molding cavities and injecting moldable material therebetween provides the nerve cuff following curing of the moldable material. An industrial mold including interfacing first and second cavities is also disclosed. A removable cassette for interposing between a first and a second molding cavity is also disclosed. Methods of making a nerve cuff are disclosed herein. Nerve cuffs produced by the foregoing molds, cassettes, industrial molds and methods are also disclosed.

### FIELD OF THE INVENTION

The present invention relates to a nerve cuff injection mold and a method of making a nerve cuff. More specifically but not exclusively, the present invention relates to a chamber nerve cuff injection mold.

### BACKGROUND OF THE INVENTION

Various types of cuff transducers intended for use as electrical or chemical interfaces with neural tissue have been described in the literature. These nerve cuffs typically have a tubular biocompatible dielectric material wall. In nerve cuffs designed to provide an electrical interface to tissues inside the nerve cuff, the inside of the nerve cuff wall supports one or more metal electrodes. Leads from the electrodes extend through and are supported by the nerve cuff wall. The nerve cuff walls must be sufficiently rigid to support the leads and electrodes. The leads may be connected to suitable signal-conditioning devices or electrical stimulation devices.

Nerve cuff electrodes have been used in stimulation systems with the goal of providing partial voluntary control of muscles that have been paralyzed as a result of lesions caused by spinal cord injury, stroke, or other central neurological system disorders. They might be used to stimulate the peripheral nervous system to alter, induce or inhibit the behavior of internal organs. In some cases, partial motor function may be restored by stimulating motor neurons or muscles below the level of the lesion. Nerve cuffs may also be used as sources for feedback for the control of closed-loop functional electrical stimulation (FES) systems.

As such, there is increasing interest in the use of nerve cuffs to preferentially monitor and/or stimulate activity in selected axons within a nerve bundle. Hoffer et al., U.S. Pat. No. 5,824,027 describes a multi-channel nerve cuff having longitudinal ridges extending along the interior walls of the nerve cuff.

The ridges divide the volume between the nerve cuff wall and the tissues within the nerve cuff into separate chambers. Electrodes are located in the chambers. This cuff structure can provide improved nerve signal recording selectivity and enhanced stimulation selectivity as compared to conventional nerve cuffs which lack separate chambers.

Fabricating a multi-chamber, multi-channel nerve cuff having one or more independent electrodes in each of several chambers is challenging, especially where the cuff is small in size. It is frequently desirable to provide nerve cuffs having internal diameters of only 2-3 mm. The challenge is compounded by the fact that such cuffs should be fabricated from material which is sufficiently flexible to minimize damage to delicate neural tissue, such as may occur with compression, sharp bending and/or stretching of the tissue. Suitable materials, such as biocompatible silicone compositions may stretch when they are manipulated. This flexibility in the nerve cuff wall may make it difficult to place electrodes in precisely determined locations and to keep the electrodes in position.

Tyler, et al. U.S. Pat. No. 5,634,462 describes multi-channel nerve cuffs constructed of stiff material. The Tyler et al. nerve cuffs are designed to deform and even penetrate a nerve, with the objective off approximating electrodes to more centrally located axons in nerves. A problem with this type of device is the possibility that the nerve could be damaged by the nerve cuff.

Nerve cuffs used for making recordings of electrical activity within nerve tissues should provide good electrical isolation of the tissues within the nerve cuffs.

Conventional molds for making such types of nerve cuffs include a base having a mold cavity on it top face defined by longitudinal grooves separated by protuberances. Silicone is poured onto the top face mold cavity followed by curing. The configuration of the top face cavity imprints a mold design on the face of the cuff that will interface with the nerve, while the opposite face of the cuff is smoothed out during early curing so as to be substantially flat. This opposite face of the cuff forms the outer side thereof.

### OBJECTS OF THE INVENTION

An object of the present invention is to provide a mold for a nerve cuff.

An object of the present invention is to provide an industrial mold for a nerve cuff.

An object of the present invention is to provide a removable cassette for a mold for a nerve cuff.

An object of the invention is to provide a method of making a nerve cuff.

An object of the invention is to provide a nerve cuff

### SUMMARY OF THE INVENTION

In accordance with an aspect of the present invention there is provided a mold for a nerve cuff comprising: a first molding body defining a first molding cavity; and a second molding body defining second molding cavity, the second molding body being mountable to the first molding body for interfacing the second molding cavity with the first molding cavity during the molding procedure; wherein when interfacing the first and second molding cavities and injecting moldable material therebetween provides the nerve cuff following curing of the moldable material.

In accordance with another aspect of the present invention there is provided a mold for a nerve cuff comprising: a first molding body defining a first molding cavity; a second molding body defining second molding cavity, the second molding body being mountable to the first molding body for interfacing the second molding cavity with the first molding cavity during the molding procedure; and plungers mountable to at least one of the first and second molding cavities, the plungers holding down electrode wires positioned on the other of the first and second molding cavities when the first and second molding cavities are interfaced, wherein when interfacing the first and second molding cavities and injecting moldable material therebetween provides the nerve cuff following curing of the moldable material.

In accordance with a further aspect of the present invention there is provided a mold for a nerve cuff comprising: a first molding body defining a first molding cavity; a second molding body defining second molding cavity, the second molding body being mountable to the first molding body for interfacing the second molding cavity with the first molding cavity during the molding procedure; and core pins mounted to at least one of the first and second molding cavities, wherein when interfacing the first and second molding cavities and injecting moldable material therebetween provides the nerve cuff following curing of the moldable material, and wherein the core pins provide for defining tubes within the nerve cuff.

In accordance with yet another aspect of the present invention there is provided an industrial mold for a nerve cuff comprising: a first base; a second base; and a molding pattern assembly mounted between the first and second bases; wherein when injecting moldable material to the molding pattern assembly, the molding pattern assembly provides a nerve cuff following curing of the moldable material.

In accordance with yet a further aspect of the present invention there is provided a removable cassette for a molding pattern assembly for a nerve cuff, the molding pattern assembly having first and second molding bodies respectively defining first and second molding cavities for being interfaced for injecting moldable material therebetween when molding the nerve cuff, the removable cassette being interposed between the first and second molding bodies, the removable cassette comprising: a main body having a central aperture for providing for at least respective portions of the first and second molding cavities to interface; and inserts mountable to the main body for being interposed between the first and second molding cavities for providing a molding pattern to the nerve cuff.

In accordance with still another aspect of the present invention there is provided a method of making a nerve cuff, the method comprising: interfacing a first molding cavity with a second molding cavity, each cavity having a predetermined molding pattern; injecting moldable material between the interfaced first and second molding cavities; and curing the moldable material thereby providing the nerve cuff.

In accordance with still a further aspect of the present invention there is provided a nerve cuff comprising: a wall band having an outer surface and an inner surface defining a lumen when said wall band member is in a dosed configuration for receiving a nerve therethrough; electrodes mounted on the inner surface for being in electrical communication with the nerve; and at least one portion of the wall band being expandable, wherein when the nerve expands the at least one portion provides for the wall band to correspondingly expand.

### BRIEF DESCRIPTION OF THE FIGURES

Embodiments of the invention will be described by way of example only with reference to the accompanying drawings, in which:

FIG. 1 is a perspective view of a mold for a nerve cuff in accordance with a non-restrictive illustrative embodiment of the present invention;

FIG. 2 is an exploded perspective view of the nerve cuff mold of FIG. 1;

FIG. 3 is a perspective bottom view of the top injection plate with end plates of the nerve cuff mold of FIG. 1;

FIG. 4 is an enlarged view of portion A of FIG. 3;

FIG. 5 is cross sectional view of the nerve cuff mold during the molding operation taken along line 5-5 of FIG. 1;

FIG. 6 is cross sectional view of FIG. 1 taken along line 6-6 thereof;

FIG. 7 is an enlarged view of portion B of FIG. 6 during the molding operation;

FIG. 8 is a perspective view of a tightness adjustment mechanism of the nerve cuff mold of FIG. 1;

FIG. 9 is an exploded perspective view of the tightness adjustment mechanism of FIG. 8;

FIG. 10 is a flow diagram of the steps of a method of manufacturing a nerve cuff in accordance with a non-restrictive illustrative embodiment of the present invention;

FIG. 11 is a perspective view of a nerve cuff in accordance with a non-restrictive illustrative embodiment of the present invention, show here in a closed configuration;

FIG. 12 is a top perspective view of the nerve cuff of FIG. 11 in an open configuration;

FIG. 13 is a bottom perspective view of the nerve cuff of FIG. 11 in an open configuration;

FIG. 14 is cross sectional view of FIG. 11 taken along line 14-14 thereof;

FIG. 15 is cross sectional FIG. 2 taken along line 15-15 thereof;

FIG. 16 is a perspective view of the nerve cuff of FIG. 1 when expanded;

FIG. 17 is cross sectional view FIG. 16 taken along line 17-17 thereof;

FIG. 18 is a top perspective view of an open nerve cuff in a “quasi tri-polar” configuration;

FIG. 19 is a perspective view of an alternative non-restrictive illustrative embodiment of the nerve cuff in a closed configuration;

FIG. 20 is a top perspective view of the nerve cuff of FIG. 19 in an open configuration;

FIG. 21 is a bottom perspective view of the nerve cuff of FIG. 19 in an open configuration;

FIG. 22 is cross sectional view of FIG. 19 along line 22-22 thereof;

FIG. 23 is cross sectional view of FIG. 20 along line 23-23 thereof;

FIG. 24 is a perspective view of a capped electrode wire in accordance with a non-restrictive illustrative embodiment of the present invention;

FIG. 25 is a perspective view of an alternative non-restrictive illustrative embodiment of the capped electrode wire of FIG. 24;

FIG. 26 is a schematic diagram of a nerve cuff connected to a stimulation/monitoring device using straight electrode wires;

FIG. 27 is a schematic diagram of a nerve cuff connected to a stimulation/monitoring device using braided electrode wires;

FIG. 28 is a perspective view of a mold for a nerve cuff in accordance with another non-restrictive illustrative embodiment of the present invention;

FIG. 29 is a perspective bottom view of the top molding body of the mold of FIG. 28;

FIG. 30 is a sectional view of FIG. 28 along line 30-30 thereof;

FIG. 31 is a perspective view of a mold for a nerve cuff in accordance with a further non-restrictive illustrative embodiment of the present invention;

FIG. 32 is a sectional view of FIG. 31 along line 32-32 thereof;

FIG. 33 is a perspective view of the mold of FIG. 31 with the injection plate having been removed;

FIG. 34 is a perspective view of the mold of FIG. 31 with the top molding body having been removed;

FIG. 35 is a side elevational view of a nerve cuff in accordance with anon-restrictive illustrative embodiment of the present invention;

FIG. 36 is a perspective view of an industrial mold for a nerve cuff in accordance with a non-restrictive illustrative embodiment of the present invention;

FIG. 37 is a perspective view of the industrial mold of FIG. 1 with the molding pattern assembly having been removed;

FIG. 38 is a perspective view of an industrial mold for a nerve cuff in accordance with another non-restrictive illustrative embodiment of the present invention;

FIG. 39 is a side elevational view of the industrial mold of FIG. 38;

FIG. 40 is a sectional schematic view of the industrial mold of FIG. 38;

FIG. 41 is a perspective view of a removable molding cassette used in nerve cuff molding in accordance with a non-restrictive illustrative embodiment of the present invention;

FIG. 42 is a top plan view of the removable cassette of FIG. 41; and

FIG. 43 is an enlarged view of portion C of FIG. 42.

### DETAILED DESCRIPTION OR ILLUSTRATIVE EMBODIMENTS

With reference to the associated drawings illustrative embodiments of the present invention will now be described so as to exemplify the invention and by no means limit the scope thereof.

Generally stated, the invention relates to injection molds for nerve cuffs having interfacing first and second mold cavities with respective molding patterns.

### Nerve Cuff Mold (100)

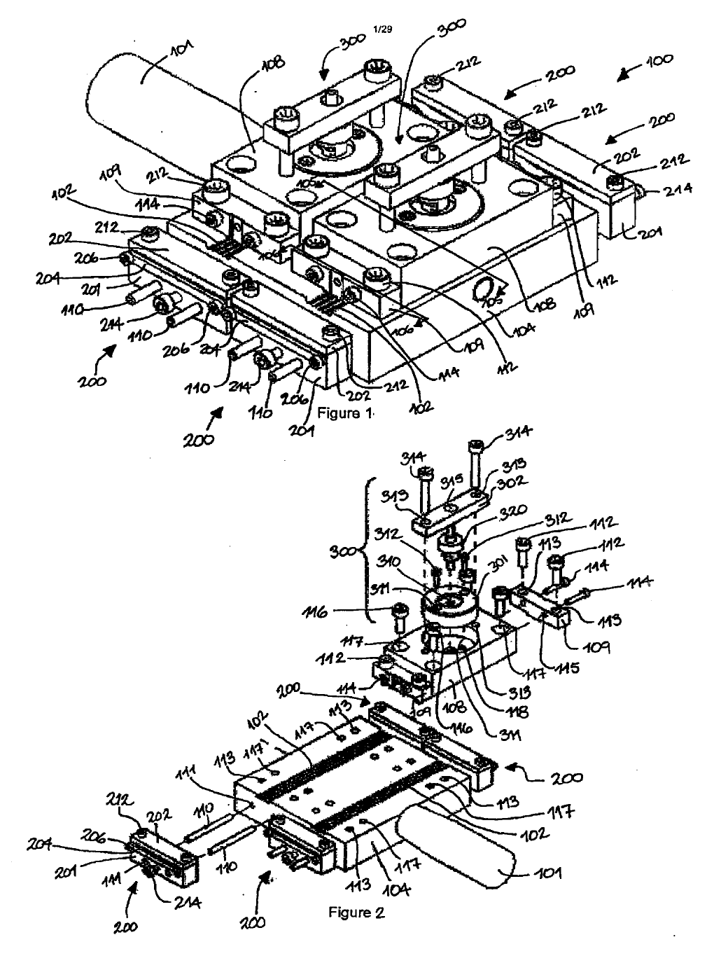

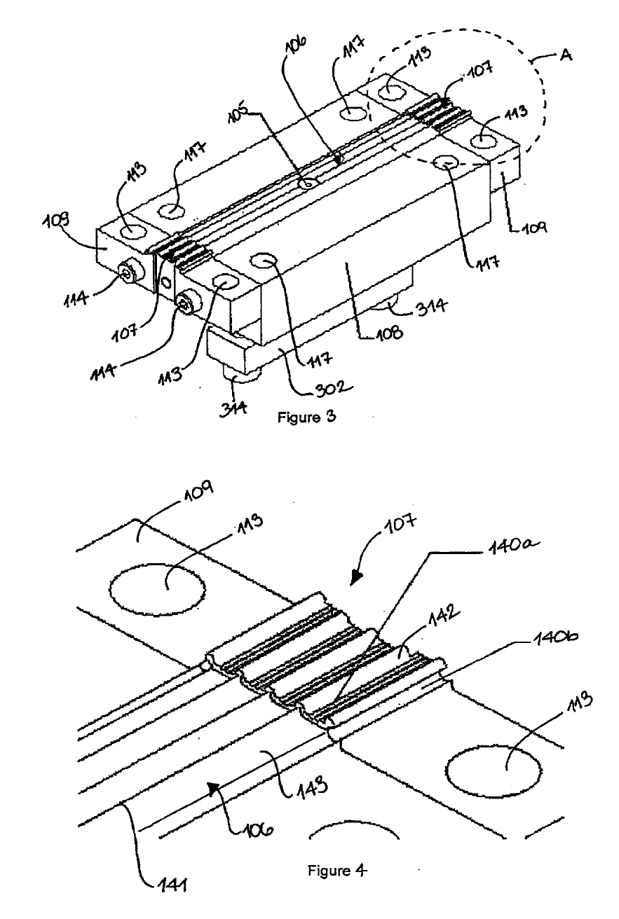

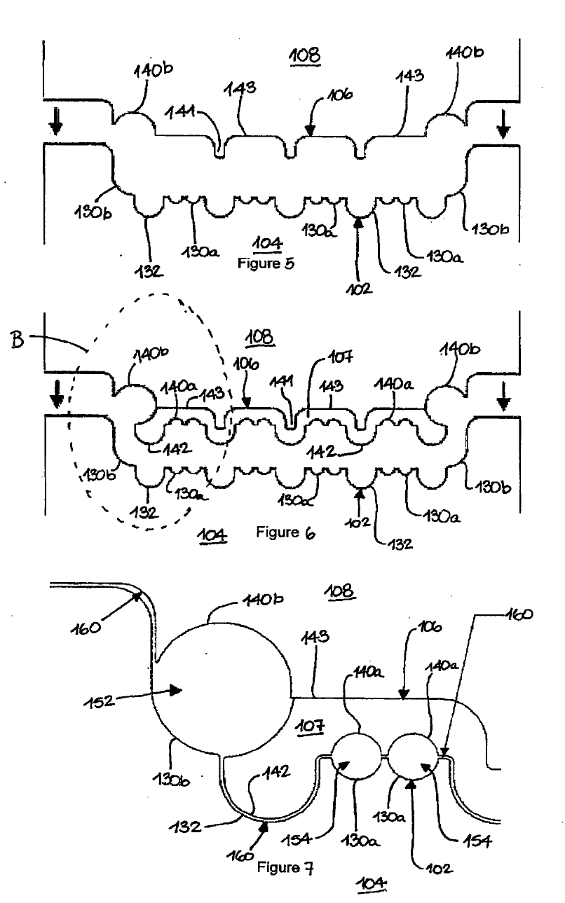

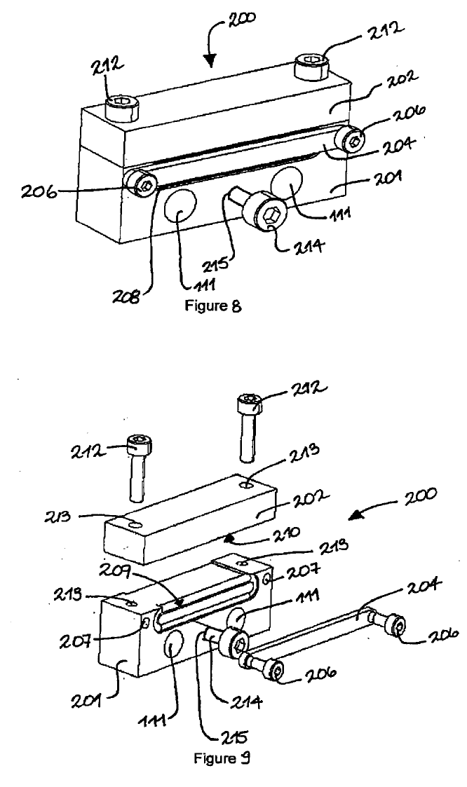

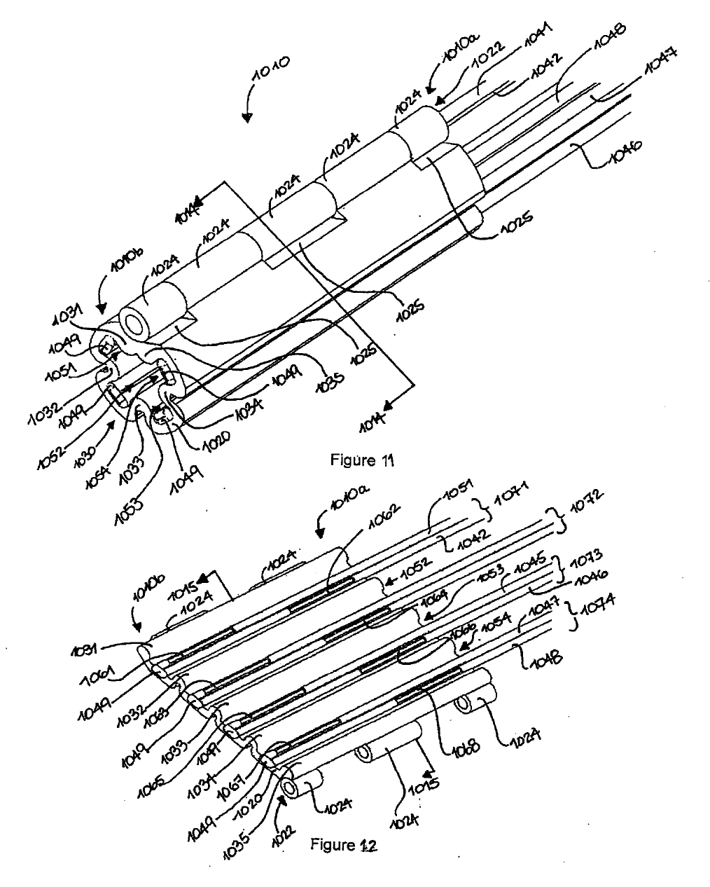

FIGS. 1 to 3 shows a mold 100 for manufacturing a nerve cuff 1010 (see FIG. 11) by using an injection molding process. In one example, the nerve cuff 1010 is manufactured using rapid-prototyping like injection. The mold 100 Includes bottom molding cavity 102 formed on a first body or base 104, as best shown in FIG. 2, second bodies or injection plates 108 with associated top molding cavity 106, as best shown in FIG. 3, tightness adjustment mechanisms 200 and an injection unit 300. A handle 101 may be used to manipulate the mold 100. Although the illustrated embodiment of the mold 100 shows two bottom molding cavities 102 and two injection plates 108 with associated top molding cavities 106, it is to be understood that the mold 100 may have a variable number of bottom molding cavities, injection plates and associated top molding cavities.

Generally, the nerve cuff mold 100 includes at least one first body 104 and at least one second body 108. The first and second bodies 104 and 108 have at least one respective molding cavity 102 and 106 which are interfaced when making a nerve cuff, such as 1010.

As mentioned above, the bottom molding cavities 102 are formed within the base 104 on which are operatively connected the injection plates 108, the end plates 109 and the tightness adjustment mechanisms 200. Also as mentioned above, each top molding cavity 106 is formed within an associated injection plate 108 on which are operatively connected the end plates 109 and the injection unit 300. Guiding members 110, which are inserted into guiding slots 111, are used to properly align the tightness adjustment mechanisms 200 with the base 104 while injection plate securing members 116 and associated injection plate securing slots 117 are used to secure the injection plates 108 to the base 104. The end plates 109 are secured to both the base 104, using first end plate securing members 112 and associated first end plate securing slots 113, and the injection plate 108, using second end plate securing members 114 and associated second end plate securing slots 115.

To protect the molding cavities 102, 106 from premature wearing, optimize flow and help prevent the implant grade silicone form bonding to the molding cavities 102, 106, a fluoropolymer powder coating, such as provided by, for example Pro-tek™ Coatings LTD. or PolyOnd™ coating, may be applied to the molding cavities 102, 106 and all injected silicone contact surfaces.

Referring to FIGS. 3 to 6 the end plate 109 guide 107 serve to secure the silicon tubing that will be laser cut to produce the interdigitating closing members 1024 forming the closure 1022, which is best seen in FIGS. 11 to 13, as well as the electrode wires 1041, 1042, 1043, 1044, 1045, 1046, 1047 and 1048. The end plate 109 guide 107 also serve to seal the molding cavities 102, 106 to permit pressurized silicone injection.

In this non-limiting example, the bottom molding cavity 102 is provided with a configuration that defines longitudinal grooves 130a, 130b, and 132, the top molding cavity 106 is provided with a configuration that defines longitudinal grooves 140b, 143 and longitudinal protuberances 141. Also, the top molding cavity 106 includes end portions 107 which define protuberances 142 and longitudinal grooves 140a.

Grooves 130b and 140b form longitudinal cavities or channels 152 which serve to properly retain the silicone tubing while grooves 130a and 140a form cavities or channels 154 which serve to properly retain the electrode wires 1041, 1042, 1043, 1044, 1045, 1046, 1047 and 1048 during the molding process. Advantageously, during the molding process, the rigidity of the silicone tubing positioned in cavities 152 may be enhanced with a stainless steel monofilaments rod equal to the silicone tubing's internal diameter.

Grooves 132 are used to form, during the molding process, the nerve cuff 1010 ridges 1031, 1032, 1033, 1034 and 1035, best seen in FIGS. 12 to 14, while the end plate 109 guide 107 sealing protuberances 142 seals grooves 132 to permit pressurized silicone injection.

Grooves 143 are used to form, during the molding process, the nerve cuff 1010 wall member 1020, best seen in FIGS. 12 to 14, while the end plate 109 guide 107 seals grooves 143 to permit pressurized silicone injection.

Protuberances 141 are used to form, during the molding process, the nerve cuff 1010 inner spaces 1037, best seen in FIG. 14, allowing the nerve cuff 1010 to expand.

The molding cavities 102, 106 may be manufactured using, for example, stainless steel. Martensitic stainless steel is recognized for its high strength, good corrosion resistance and as being a high harness alloy.

The bottom molding cavity 102, the top molding cavity 106 and the end plate 109 guide 107 are advantageously designed to take in consideration the coating thickness, as shown in FIG. 6. In which case, the bottom molding cavity 102, the top molding cavity 106 and the end plate 109 guide 107 are machined so as to obtain at least an almost perfect fit when they are coated and assembled; the available space 160 between the bottom molding cavity 102, the top molding cavity 106 and the end plate 109 guide 107 should be equal to about twice the coating thickness.

The bottom molding cavity 102 grooves 130a, 130b, 132, the top molding cavity 106 grooves 140b, 143 and protuberances 141, and the end plate 109 guide 107 grooves 140a and sealing protuberances 142 may be created using wire electric discharge machining (EDM) or with high speed milling machining.

Advantageously, the diameter of the injection hole 105 may be set to 1 mm or lower, to give but one non-restrictive example.

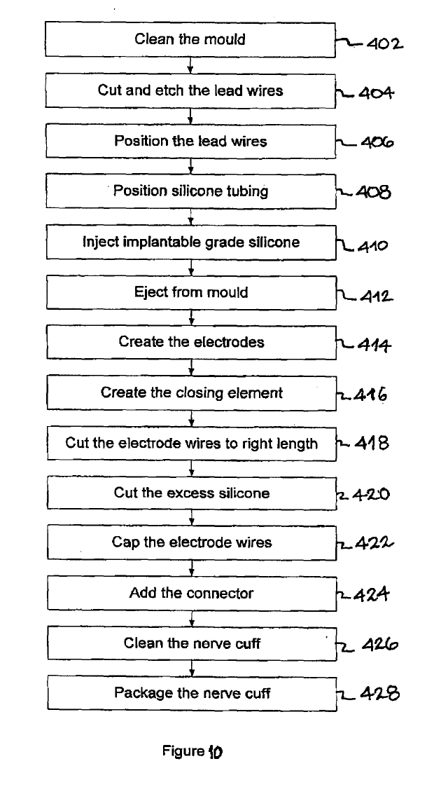

During the molding process, if the electrode wires 1041, 1042, 1043, 1044, 1045, 1046, 1047 and 1048 are not fixed correctly, the pressure exerted by the silicone flow from the injection hole 105 may move the wires from their respective positioning slots 130a. Referring to FIGS. 7 and 8, the tightness adjustment mechanism 200 includes a main body 201 and an electrode clamp 202, which may be secured to the main body 201 using associated securing members 212 and corresponding securing slots 213. Since the electrode wires 1041, 1042, 1043, 1044, 1045, 1046, 1047 and 1048 secured by the tightness adjustment mechanism 200 are part of the final product, an O-ring 208 is positioned in a receiving cavity 209 in the main body 201, best seen in FIG. 8, and a silicone sheet 210 positioned under the electrode clamp 202 in order to protect the ETFE coating of the electrode wires 1041, 1042, 1043, 1044, 1045, 1046, 1047 and 1048, secured by the electrode clamp 202, from clamp marking. The O-ring 208 may be made, for example, of rubber or any other such material, and is secured to the main body 201 using holding bar 204 and bar securing members 206, which interact with securing slots 207. When the electrode wires 1041, 1042, 1043, 1044, 1045, 1046, 1047 and 1048 are secured between the main body 201 and the electrode clamp 202, the tightness of the electrode wires 1041, 1042, 1043, 1044, 1045, 1046, 1047 and 1048 may be adjusted by rotating the tightness adjustment member 214. The tightness adjustment member 212, which is inserted in a threaded hole 215 within the main body 201, may be rotated until it enters in contact with the end plate 109, which displaces the tightness adjustment mechanism 200 away from the base 104 of the molding apparatus 100. The tightness adjustment member 214 may then be rotated, moving the tightness adjustment mechanism 200 farther away, until the desired tightness of the electrode wires 1041, 1042, 1043, 1044, 1045, 1046, 1047 and 1048 is achieved.

### Injection Unit

Referring back to FIG. 2, the injection unit 300, which in this example is a rapid prototyping injection unit, uses a commercially available check-valve 320 which enables the flow of silicone to go to the injection chamber, formed by the lower 102 and upper 106 molding cavities, through the injection hole 105 but prevents it from going backwards. The check-valve 320 is used to inject silicone under a controlled pressure and allowing, once the injection has been completed, the removal of the pressuring equipment while maintaining a stable pressure during curing.

During the curing process, silicone contained in the check-valve 320 will also cure within the check-valve 320. As a new check-valve 320 will be required for each injection, the check-valve 320 should be set within the injection unit 300 so as to be replaceable. In this regards, the check-valve 320, which is operatively engaged to the injection nozzle 301, itself operatively communicating with the injection hole 105, is held in place by the back plate 302. The back plate 302 applies a downward force on the engaged check-valve 320 and injection nozzle 301 in order to prevent the injection nozzle 301 from being ejected due to the build up of pressure when the injection chamber formed by the lower 102 and upper 106 molding cavities is filled with silicone.

The injection nozzle securing members 312 and associated injection nozzle securing slots 311 are used to secure the injection nozzle 301 to the injection plate 108, while the back plate securing members 314 and associated back plate securing slots 313 are used to secure the back plate 302 to the injection plate 108. The back plate securing members 314 and associated back plate securing slots 313 also provide the downward force on the check-valve 320, securing it between the injection nozzle 301 and the back plate 302. To replace the check-valve 320, the back plate securing members 314 may be disengaged from their associated back plate securing slots 313, allowing the removal of the back plate 302 so that the check-valve 320 may be replaced.

The injection nozzle 301 is advantageously made of non-adhesive material, such as, for example, Teflon® or polytetrafluoroethylene (PTFE) so that once the silicone located in the injection nozzle 301 cures, it may be easily removed and the injection nozzle 301 cleaned. Furthermore, to reduce metal-to-metal friction and improve lubricity during injection, the injection nozzle 301 may be machined from a polytetrafluoroethylene (PTFE) rod.

### Method for Manufacturing a Nerve Cuff

A method for manufacturing a nerve cuff is depicted by the flow diagram shown in FIG. 9. The steps of the method are indicated by blocks 402 to 428. The method begins at block 402 where the mold is cleaned, for example with a 70% 2-propanol solution.

Then, at block 404, the electrode wires 1041, 1042, 1043, 1044, 1045, 1046, 1047 and 1048 are cut to appropriate lengths and etched. The etching ensures an appropriate adherence between implant grade silicone and ETFE coated electrode wires 1041,1042, 1043, 1044, 1045, 1046, 1047 and 1048.

At block 406, the electrode wires 1041, 1042, 1043, 1044, 1045, 1046, 1047 and 1048 are positioned in grooves 130a of the bottom molding cavity 102. The strain of the electrode wires 1041, 1042, 1043, 1044, 1045, 1046, 1047 and 1048 is then adjusted with tightness adjustment mechanism 200.

At block 408, the closing elements 1024 tubing are placed in their grooves 130b. Advantageously, small stainless steel wires may be positioned inside the closing elements 1024 tubing in order to prevent movement during the molding process and insure their proper alignment.

Then, at block 410, the top molding cavity 106 is secured to the bottom molding cavity 102 and implant grade silicone, for example Room Temperature Vulcanisation (RTV) silicone, is injected using the injection unit 300 to form the wall member 1020. The wall member 1020 serves to adhere to and support the closing elements 24 along both edges of the nerve cuff 10 and the electrode wires 1041, 1042, 1043, 1044, 1045, 1046, 1047 and 1048.

At block 412, the top molding cavity 106 is removed and the wall member 1020 is ejected from the bottom molding cavity 102. It is to be understood that the wall member 1020 is not to be ejected from the bottom molding cavity 102 until a suitable amount of time has elapsed since the injection of the implant grade silicone to allow the implant grade silicone to properly cure. This period of time may vary, depending on the type of implant grade silicone used.

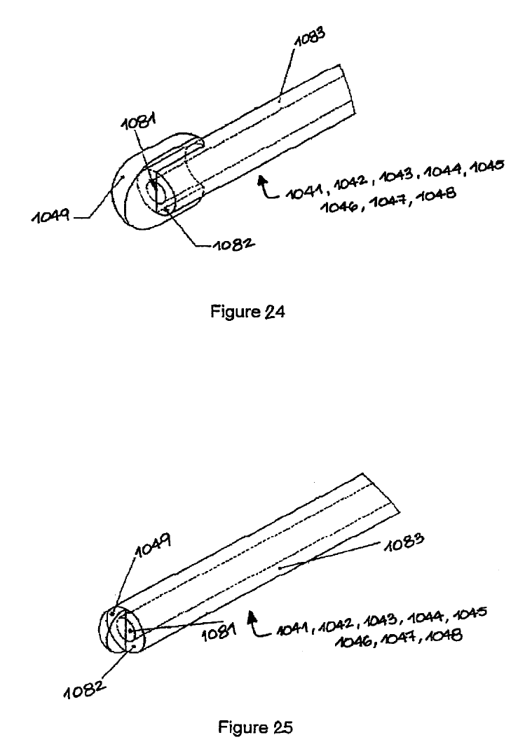

Referring also to FIG. 12, at block 414, the electrodes (1061, 1062), (1063, 1064), (1065, 1066) and (1067, 1068), or alternatively and with reference to FIG. 18, electrodes (1061a, 1061b, 1062), (1063a, 1063b, 1064), (1065a, 1065b, 1066) and (1067a, 1067b, 1068), are created by removing lengths of ETFE insulation from the electrode wires 1041, 1042, 1043, 1044, 1045, 1046, 1047 and 1048. The ETFE insulation may be removed using, for example, a CO₂ TEA (transverse excited atmospheric) laser for a first rough pass followed by an Excimer laser to remove the thin layer of coating that may have been left by the CO₂ TEA, thus exposing the core 1081 (see FIG. 24) of the electrode wires 1041, 1042, 1043, 1044, 1045, 1046, 1047 and 1048. The first set of electrical contacts 61, 63, 65 and 67 and the second set of electrical contacts 1062, 1064, 1066 and 1068 being positioned generally at opposed ends of the nerve cuff 10. Alternatively, for quasi-tripolar configurations, the indifferent electrodes (1061a, 1061b), (1063a, 1063b), (1065a, 1065b) and (1067a, 1067b) being positioned generally symmetrically at the extremities of the nerve cuff 1010 while the recording electrodes 1062, 1064, 1066 and 1068 are generally positioned in the center of the nerve cuff 1010 with respect to its total length.

Then, at block 416, the closing elements 1024 are cut from the closing elements 1024 tubing using, for example, a Nd-Yag laser, such that the closing elements 1024 on each side of the nerve cuff 10 form an interdigitating pattern such as shown in FIG. 12.

At block 418, the electrode wires 1041, 1042, 1043, 1044, 1045, 1046, 1047 and 1048 are cut using, for example, a Nd-Yag laser, such that they protrude beyond the desired length of the wall member 1020 by approximately 2.0 mm.

At block 420, the unused portion of the wall member 1020 is cut to the desired length using, for example, pliers.

At block 422, the protruding ends of the electrode wires 1041, 1042, 1043, 1044, 1045, 1046, 1047 and 1048 are covered by implantable grade silicone, forming an electrode cap 1049 as shown in FIG. 24.

Then, at block 424, a connector (not shown) may be connected to the electrode wires 1041, 1042, 1043, 1044, 1045, 1046, 1047 and 1048 for connection of the nerve cuff 10 to some further interface or device (not shown). Furthermore, the electrode wire pairs (1041, 1042), (1043, 1044), (1045, 1046) and (1047, 1048) may be braided so as to reduce EM interferences.

At block 426, the lead, resulting from the assembly of the nerve cuff 10 with a connector at block 424, is cleaned with, for example, a 70% 2-propanol solution and, at block 428, the lead is package in sterile packaging for storage or shipment.

### Expandable Multi-Channel Nerve Cuff

Generally stated, an implantable interface in the form of a expandable multi-channel nerve cuff, hereinafter referred to as “nerve cuff”, according to an illustrative embodiment of the present invention is used for stimulating nerve tissues or recording electroneurographic signal in human beings or other creatures possessing nervous systems. The interface may have particular application in functional electrical stimulation (“FES”) of the neuromuscular system

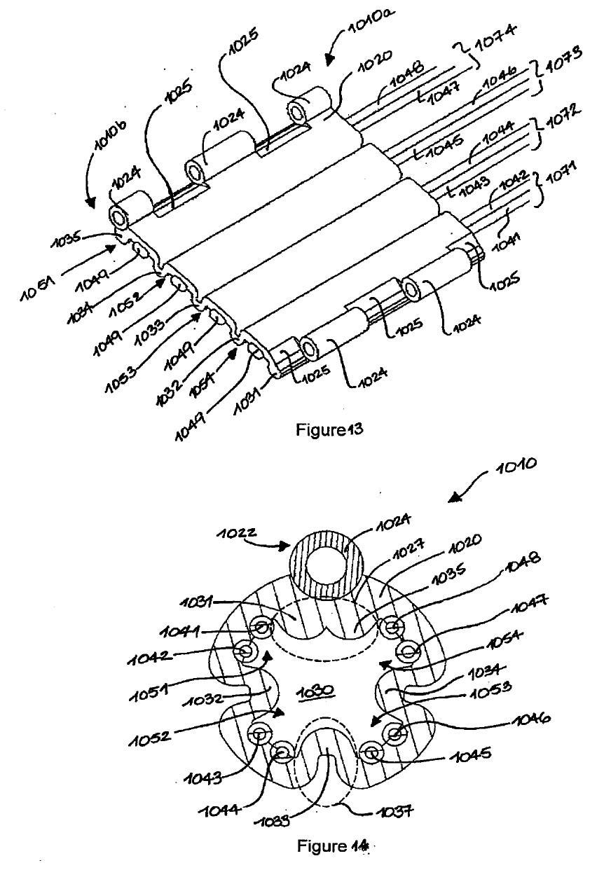

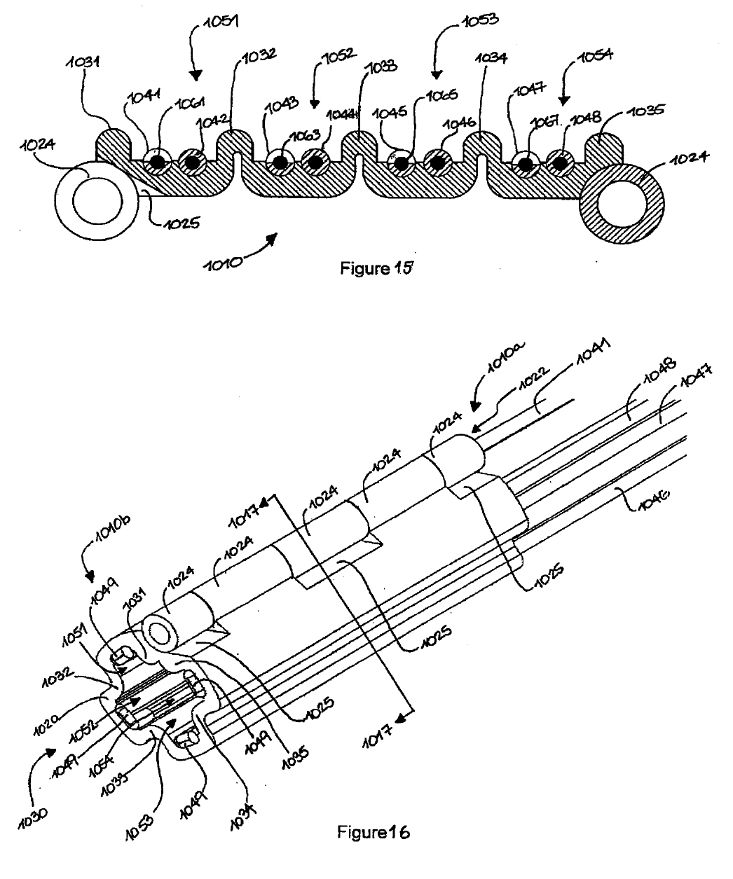

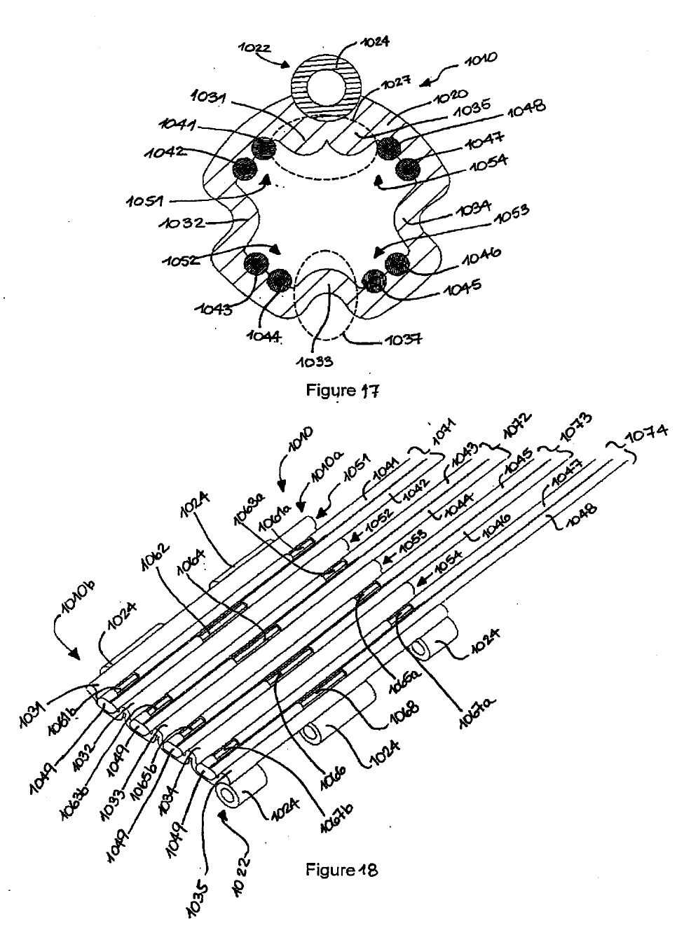

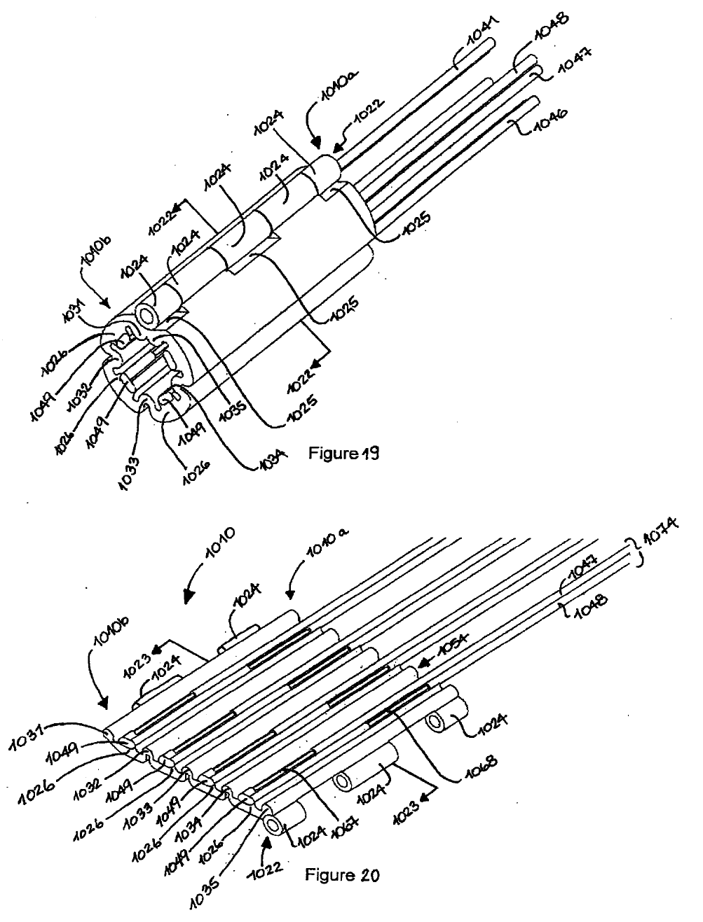

Referring to FIGS. 11 to 5, there is shown a non-limitative illustrative embodiment of a nerve cuff 1010 in a closed configuration (FIG. 11), in an open configuration (FIGS. 12 and 13) and in cross sections (FIGS. 14 and 15). The nerve cuff 1010 has a wall member 1020 which has a generally tubular configuration when in a closed configuration, as shown in FIG. 11. The wall member 1020 encloses a lumen 1030 which is sized to receive a nerve or other bodily tissue. A closure 1022 allows the nerve cuff 1010 to be opened to receive a nerve or other bodily tissue in lumen 1030. Closure 1022 may then be closed to isolate the bodily tissue within lumen 1030. The closure 1022 may be any suitable closure, however, the closure 1022 advantageously comprises interdigitating closing members 1024 affixed on either side of the wall member 1020 combined with angular cuts 1025. Closure 1022 may be secured in a closed configuration by inserting a rod-like member (not shown) through the interdigitated closing members 1024.

Five ridges 1031, 1032, 1033, 1034 and 1035 delimitate four chambers 1051, 1052, 1053 and 1054, each including a pair of electrode wires (1041, 1042), (1043, 1044), (1045, 1046) and (1047, 1048), respectively. It is to be understood that while the nerve cuff 10 of the illustrative embodiment contains four chambers 1051, 1052, 1053 and 1054, the nerve cuff 1010 may have a different number of chambers and/or ridges and/or pairs of electrodes, depending on the application.

Furthermore, in an alternative embodiment, the wall member 1020 may have openings located within one or more of the chambers 1051, 1052, 1053 and 1054 so as to allow connection to an agent delivery system for agents such as, for example, a pharmaceutical agent.

### Wall Member and Ridges

Referring to FIGS. 11 to 14, the wall member 1020 and the ridges 1031, 1032, 1033, 1034 and 1035 may be made by molding implant grade silicone. The molding process will be detailed further below.

When the nerve cuff 1010 is in a closed configuration, ridges 1031 and 1035 act as a seal 1027, as shown in FIG. 14, from the external environment and consist of bumps integrated into the wall member 1020. As for ridges 1032, 1033 and 1034, they consist of generally V-shaped bumps having an inner space 1037 that behave in an accordion like fashion, such that the nerve cuff 10 may tolerate expansion due to, for example, post surgical nerve swelling or handle nerve size variability easily.

In the illustrative embodiment, ridges 1032, 1033 and 1034 may provide a nerve cuff 1010 having a wall member 1020 made of 3.5 MPa silicone with the ability to accommodate a nerve area increase of up to approximately 20%, as shown in FIGS. 16 and 17, without compromising venular blood flow. The accordion like behavior of ridges 1032, 1033 and 1034 may be observed, for example, by comparing the inner space 1037 of ridge 1033 before expansion, shown in FIG. 14, with the resulting inner space 1037′ after expansion, shown in FIG. 17.

Advantageously, the wall member 1020 thickness around ridges 1032, 1033 and 1034 may be approximately 0.2 mm compared to 0.4 mm elsewhere in the nerve cuff 1010. With a softer elastomer such as 1.0 MPa silicone which is a liquid silicone rubber, the nerve area increase the nerve cuff 1010 may accommodate may reach up to approximately 90%. However, 1.0 MPa silicone may complicate the manufacturing process. The 3.5 MPa silicone, which is an adhesive, provides for a less complicated manufacturing process and is well suited for injection molding. Moreover, 3.5 MPa silicone provides for cohesion between the electrode wires (1041, 1042), (1043, 1044), (1045, 1046) and (1047, 1048) and the wall member 1020.

### Electrodes

The wire used for the electrode wires (1041, 1042), (1043, 1044), (1045, 1046) and (1047, 1048) may be, for example, a 316 LVM multistrand wire 19×0.0012″ (0.006″ diameter, Fort Wayne Metals Production Number 72073; Hard temper) coated with a 0.003″ thick ETFE insulation (Tempflex) for a total outer diameter of 0.012″.

Referring back to FIG. 12, the pairs of electrode wires (1041, 1042), (1043, 1044), (1045, 1046) and (1047, 1048) are used to create electrodes (1061, 1062), (1063, 1064), (1065, 1066) and (1067, 1068), respectively, in “bi-polar” configurations. This means that each electrode channel 1071, 1072, 1073 and 1074 comprises two electrical contacts. The first electrical contacts consisting of the electrodes 1061, 1063, 1065 and 1067 and the second electrical contacts is made of the electrodes 1062, 1064, 1066 and 1068. For stimulation, and referring to FIG. 20, this provides an arrangement where selective, independently configurable electrical stimulation may be delivered for each channel, axially with respect to the nerve. In such case, the channel 1074 would consists of the anode 1067 and the cathode 1068, or reversely. Selective stimulation may also be delivered in a radial fashion, e.g. using electrical contact 1061 as cathode and electrical contact 1065 as anode, or by combining radial and longitudinal stimulation (e.g. 1061a as anode and 1065b as cathode). Grouping electrical contacts may also be made to provide more exposed nerve area to stimulating with the effect of decreasing selectivity. For signal recording, the electrical contact 1061, 1063, 1065 and 1067 may act as indifferent electrodes while the electrical contacts 1062, 1064, 1066 and 1068 may act as recording electrodes of the nerve cuff 1010, or reversely. For applications where recording or stimulation directionality may be of importance, the electrical contacts 1061, 1063. 1065 and 1067 may be located near the proximal end 10a of the nerve cuff 10 and the electrical contacts 1062, 1064, 1066 and 1068 may be located near the distal 10b end of the nerve cuff 1010, or reversely.

The electrodes (1061, 1062), (1063, 1064), (1065, 1066) and (1067, 1068) may be created by removing part of the ETFE insulation of the corresponding electrode wires (1041, 1042), (1043, 1044), (1045, 1046) and (1047, 1048). The electrical contacts 1061, 1063, 1065 and 1067 are created from electrode wires 1041, 1043, 1045 and 1047 while the electrical contacts 1064, 1064, 1066 and 1068 are created from the remaining electrode wire 1042, 1044, 1046 and 1048 of each corresponding electrode channel 1071, 1072, 1073 and 1074.

In an alternative embodiment, illustrated in FIG. 18, the pairs of electrode wires (1041, 1042), (1043, 1044), (1045, 1046) and (1047, 1048) may be used to create electrodes (1061a, 1061b, 1062), (1063a, 1063b, 1064), (1065a, 1065b, 1066) and (1067a, 1067b, 1068), respectively, in a “quasi tri-polar” configurations. This means that each electrode channel 1071, 1072, 1073 and 1074 comprises two electrical contacts acting as indifferent electrodes (1061a, 1061b), (1063a, 1063b), (1065a, 1065b) and (1067a, 1067b) and one central electrical contact acting as a recording electrode 1062, 1064, 1066 and 1068, respectively. The indifferent electrodes (1061a, 1061b), (1063a, 1063b), (1065a, 1065b) and (1067a, 1067b) may be advantageously positioned symmetrically with respect to the total length of the nerve cuff 1010, a first set of indifferent electrodes 1061a, 1063a, 1065a and 1067a being located near the proximal end 1010a of the nerve cuff 1010 and a second set of indifferent electrodes 1061b, 1063b, 1065b and 1067b being located near the distal end 1010b of the nerve cuff 1010, or reversely. The recording electrodes 1062, 1064, 1066 and 1068 may be advantageously located in the center 1010c of the nerve cuff 1010.

Creating the indifferent electrodes (1061a, 1061b), (1063a, 1063b), (1065a, 1065b) and (1067a, 1067b) from the same electrode wire 1041, 1043, 1045 and 1047, respectively, for each electrode channel 1071, 1072, 1073 and 1074, avoids welding and provides a proper impedance match.

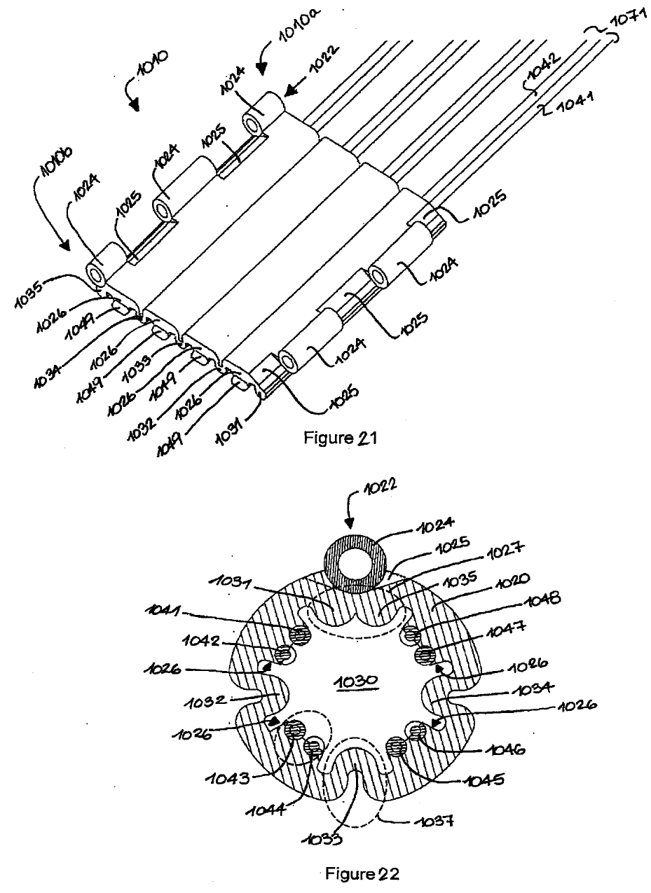

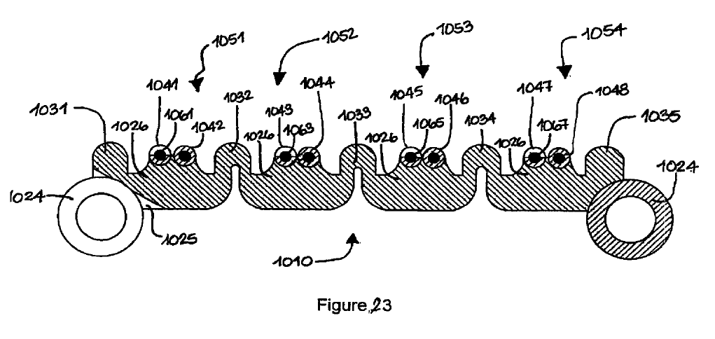

In a further alternative embodiment, illustrated in FIGS. 19-23, the wall member 1020 may include protuberances 1026 on which the pairs of electrode wires (1041, 1042), (1043, 1044), (1045, 1046) and (1047,1048) may be positioned so as to be generally at the same level as the ridges 1031, 1032, 1033, 1034 and 1035. This elevation with respect to the surface of the wall member 20 allows the electrode wires (1041, 1042), (1043, 1044), (1045, 1046) and (1047, 1048) to be located near the surface the nerve, this diminishes the nerve/electrode impedance and results in higher sensibility to nerve activity. However, the presence of the protuberances 1026 may limit the possible expansion of the nerve cuff 1010.

### Electrode Capping

During the manufacturing process, the electrode wires (1041, 1042), (1043, 1044), (1045, 1046) and (1047, 1048) are positioned so as to protrude approximately 2.0 mm beyond the wall member 1020 at the distal end 1010b of the nerve cuff 10. The protruding ends of the electrode wires (1041, 1042), (1043, 1044), (1045, 1046) and (1047, 1048) are covered by silicone forming an electrode cap 1049, as may be seen in FIGS. 11-13, 16 and 18-21. However, before the application of the silicone, the outer surface 1083 of the ETFE insulation on the protruding end of the electrode wires (1041, 1042), (1043, 1044), (1045, 1046) and (1047, 108) may advantageously be etched to ensure proper bonding of the silicone forming the cap 1049, as shown in FIG. 24. Etching can be done via chemical reaction or plasma. Etching modifies the surface property of ETFE to increase bonding strength.

In an alternative embodiment, the electrode wires (1041, 1042), (1043, 1044), (1045, 1046) and (1047, 1048) may be cut or positioned so as not to protrude beyond the wall member 1020. In this alternative embodiment, some silicone would flow over the end of the electrode wires (1041, 1042), (1043, 1044), (1045, 1046) and (1047, 1048) and mainly bond to the exposed inner surface 1082 of the ETFE insulation, as shown in FIG. 25. It is advantageous that the silicone cap 1049′ have good adhesion with the end of the electrode wires (1041, 1042), (1043, 1044), (1045, 1046) and (1047, 1048) to prevent possible separation from the end wire, which would allow for the core 1081 to be exposed.

### Wire Braiding

During the manufacturing process, the pairs of electrode wires (1041, 1042), (1043, 1044), (1045, 1046) and (1047, 1048) of each respective electrode channel 1071, 1072, 1073 and 1074 are positioned so as to protrude for some length beyond the wall member 1020 at the proximal end 1010a of the nerve cuff 1010 so as to allow the connection of the nerve cuff 1010 to a suitable signal-conditioning, monitoring or electrical stimulation device.

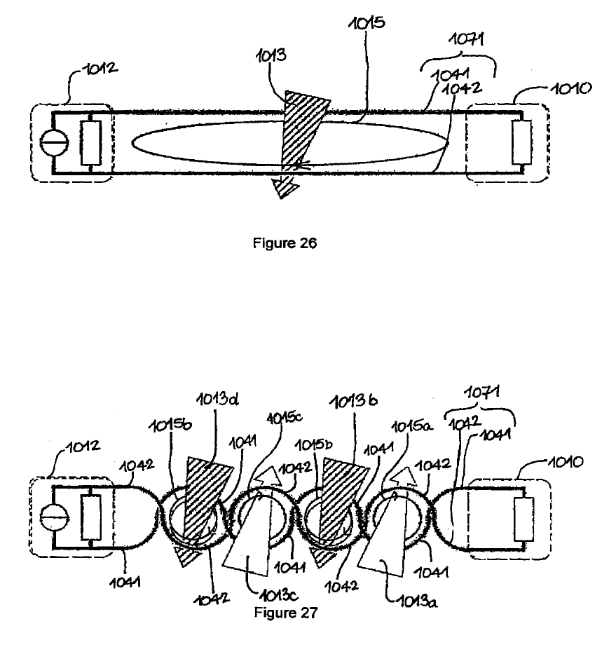

In a conventional arrangement the electrode wires of each electrode wire pairs (1041, 1042), (1043, 1044), (1045, 1046) and (1047, 1048) are laid in a parallel fashion from the nerve cuff 1010 to the signal-conditioning, monitoring or electrical stimulation device. FIG. 26 illustrates electrode wire pair (1041, 1042) of electrode channel 1071 being connected to the signal-conditioning, monitoring or electrical stimulation device 1012 in the described conventional arrangement. This arrangement, however, is susceptibility to electromagnetic (EM) interference 1013 generated by the current loop formed by the connection between the nerve cuff 1010 and the signal-conditioning, monitoring or electrical stimulation device 1012. This EM interference 1013 induces an electrical current, indicated by arrow 1015, which causes noise in the signals being transmitted along the electrode channel 1071.

Referring to FIG. 27, the electrode wires 1041, 1042 may be braided or twisted, creating smaller EM interferences 1013a, 1013b, 1013c and 1013d that induce electrical currents, indicated respectively by arrows 1015a, 1015b, 1015c and 15d, which alternate in direction from one loop to another, so that the interference is cancelled. This reduction in the susceptibility to EM interference results in an appreciable reduction in the electrical noise level present in the signals being transmitted along the electrode channel 1071.

Although, for the sake of clarity, only electrode wire pair (1041, 1042) of electrode channel 1071 was shown and discussed, it is to be understood that the above discussion similarly applies to the remaining electrode pairs and electrode channels.

### Closure

The closure 1022 may be fabricated from a single length of implant grade commercial silicone tubing, for example AlliedSil™ Tubing 0.012″×0.025″, of course some clinicians may prefer larger tubing to make the insulation of cuff easier during surgery. A variety of cuff diameters may be suitable to ease cuff insulation. In the illustrative embodiments shown in FIGS. 11-13, 16 and 18-21, the tubing is cut into interdigitated closing elements 1024 in the form of tubular links on each side of the nerve cuff 1010 to realize a piano hinge interlocking system. The closing elements 1024 are combined with cuts 1025 for a good seal of the closure 1022 when the nerve cuff 1010 is in a closed configuration, as shown in FIGS. 11, 16 and 19. Furthermore, when the nerve cuff 1010 is in a closed configuration, the peripheral contacts of ridges 1031 and 1035 form a sealing feature 1027, as shown in FIGS. 14, 17 and 22, that seals the surrounded nerve or other bodily tissue from the external environment. As mentioned previously, the closure 1022 may be secured in the closed configuration by inserting a rod-like member, for example a standard permanent polypropylene suture wire, through the interdigitated dosing member; 1024.

### Nerve Cuff Mold (500)

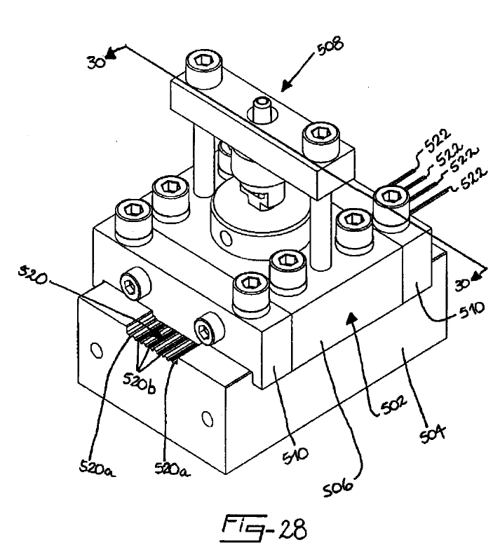

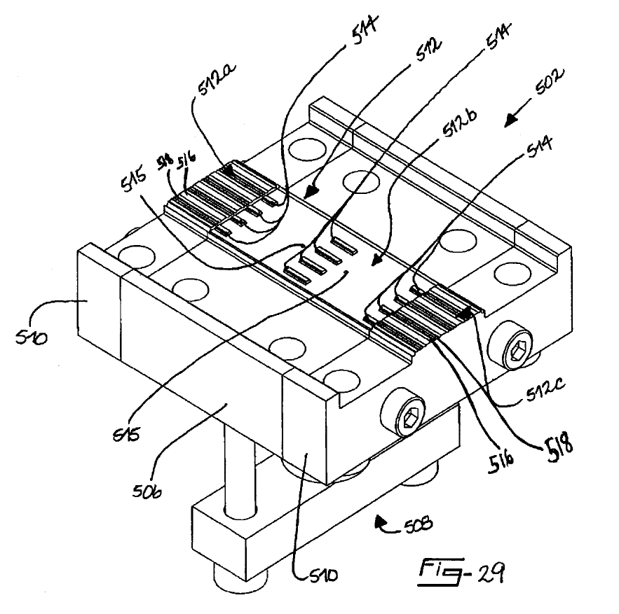

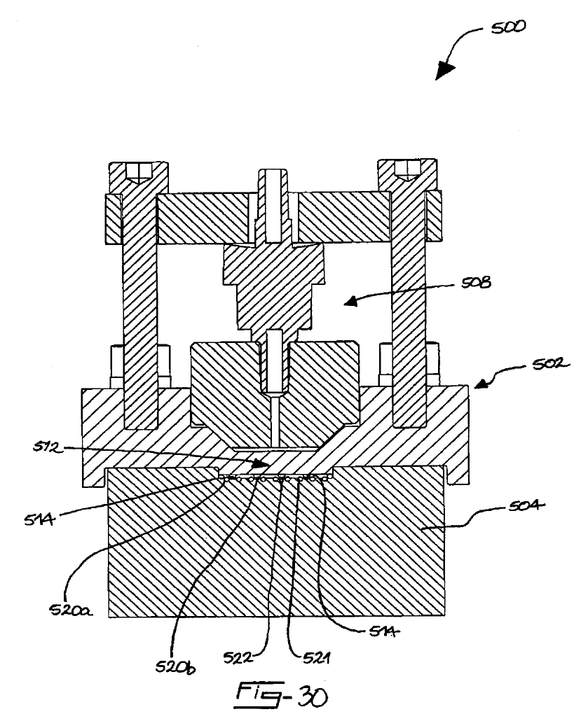

FIG. 28 shows an injection mold 500 for manufacturing a nerve cuff in accordance with another non-restrictive illustrative embodiment of the present invention. Mold 500 is similar to mold 100 and as such particular attention will be paid to the differences between the molds 500 and 100. Mold 500 includes first and second interfaced bodies, 502 and 504 respectively as shown in FIGS. 28 to 30. In this example, the first and second bodies 502 and 504 are upper and bottom bodies respectively. Upper body 502 includes an injection plate 506 having an injection unit 508 mounted thereon and a pair of end plates 510 mounted at each end thereof. Body 502 is mounted to body 504 which defines a base.

As shown in FIGS. 29, the injection plate 506 and the end plates 510 define a top molding cavity 512. The molding cavity has a pair of end portions 512a and 512c and a median section 512b therebetween. The median portion 512b has a generally flat surface and includes a plurality of plungers 514, which are in the form of generally rectangular protuberances, as well as holes 515 for releasing the injected silicone. The end portions 512a and 512c define alternating protuberances 516 and grooves 518. The top molding cavity 512 is interfaced with a bottom molding cavity 520 formed on the base 504, as shown in FIG. 28.

With reference to FIGS. 28 and 30, the bottom cavity 520 includes longitudinal grooves 520a and 520b, which are tube grooves and wire grooves respectively for receiving tubes 521 and electrode wires 522 respectively.

In operation, the tube and wire grooves 520a and 520b are injected with silicone and then tubes 521 and electrode wires 522 are respectively positioned therein. The top molding cavity 512 with the plungers 514 is interfaced with the bottom molding cavity 520. In this way, the plungers 514 hold down the wires 522 during injection as shown in FIG. 30. Once this first phase of injection is complete, the plungers 514 are removed and the top molding cavity 512 is reapplied onto the bottom molding cavity 520 in order to inject silicone and fill the spaces formerly occupied by the plungers 514. Alternatively, the top molding cavity 512 is replaced with another top molding cavity that does not have any plungers 514. In this way the open spaces left by the plungers 514 can be filled as well as provide a further thin layer that creates a generally flat surface.

### Hybrid Nerve Cuff Mold (600)

FIGS. 31 to 34 show a hybrid nerve cuff mold 600 for manufacturing a nerve cuff 650 (see FIG. 35) in accordance with another non-restrictive illustrative embodiment of the present invention. Mold 600 is similar to molds 100 and 500, and again mostly the differences therewith will be discussed herein for concision proposes only. With particular reference to FIGS. 31 and 32, mold 600 includes first and second interfaced bodies, 602 and 604 respectively. As before, the first and second bodies 602 and 604 are upper and bottom bodies respectively. Upper body 602 includes an injection plate 606 having an injection unit 608 mounted therein and a pair of end plates 610 mounted at each side thereof. The injection unit 608 includes an injection nozzle 612 and a check valve 614. Body 602 is mounted to body 604 which defines a base. The mold 600 also includes a tightness adjustment mechanism 616.

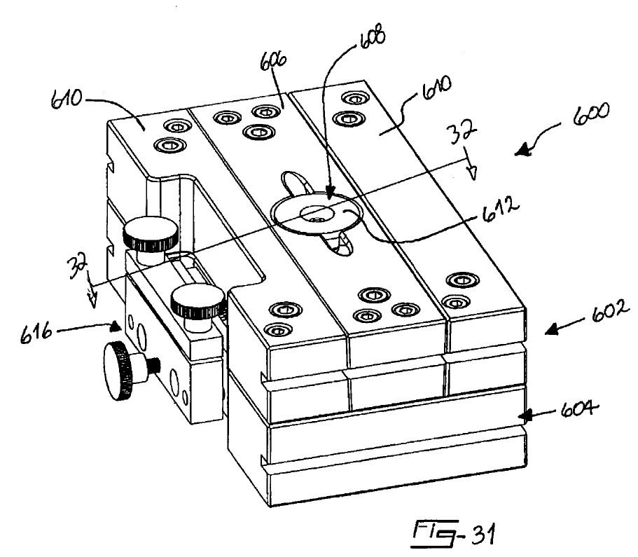

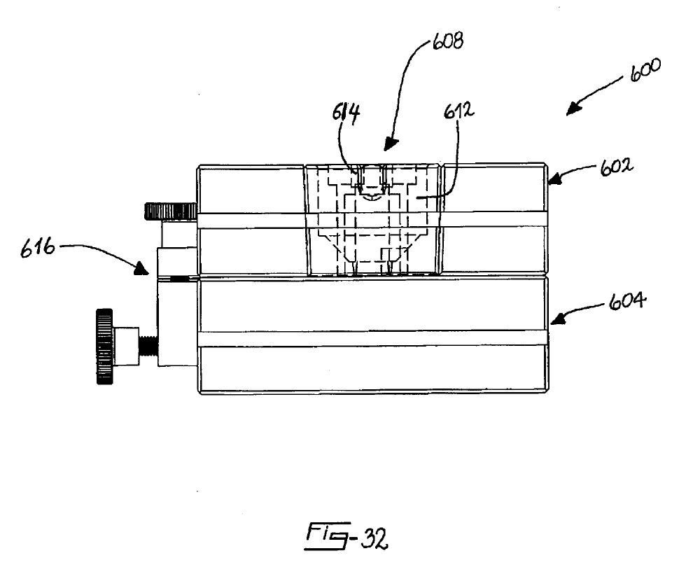

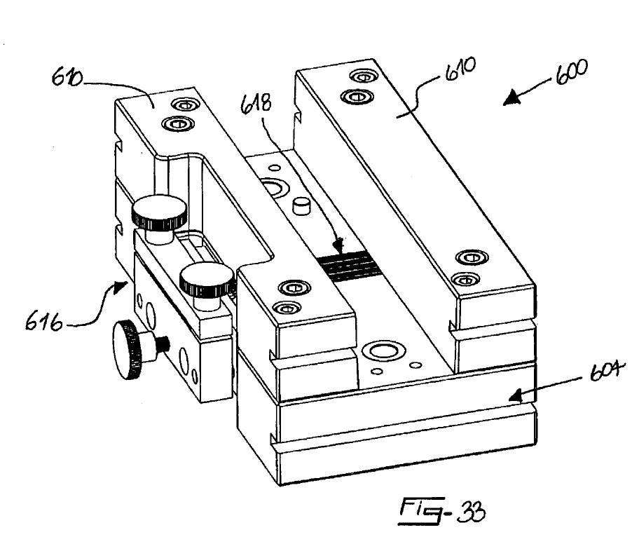

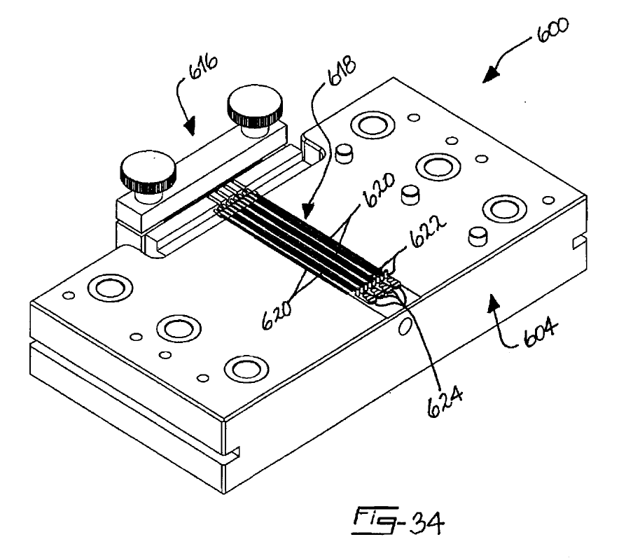

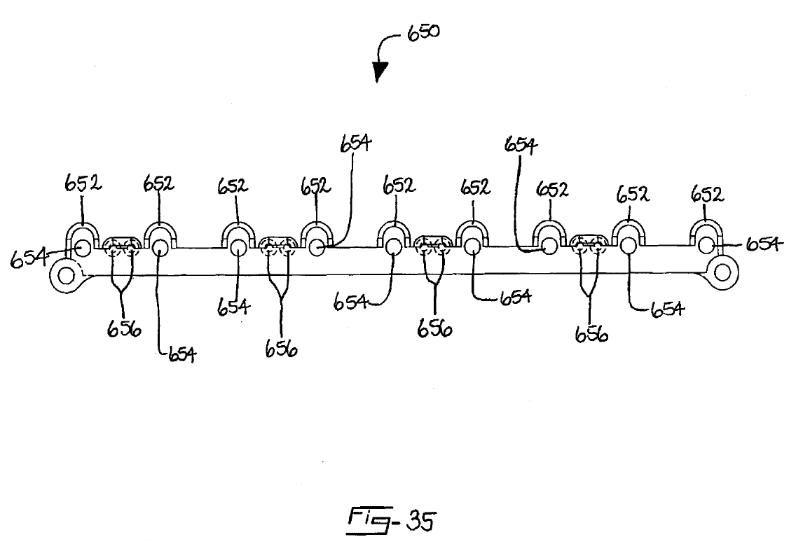

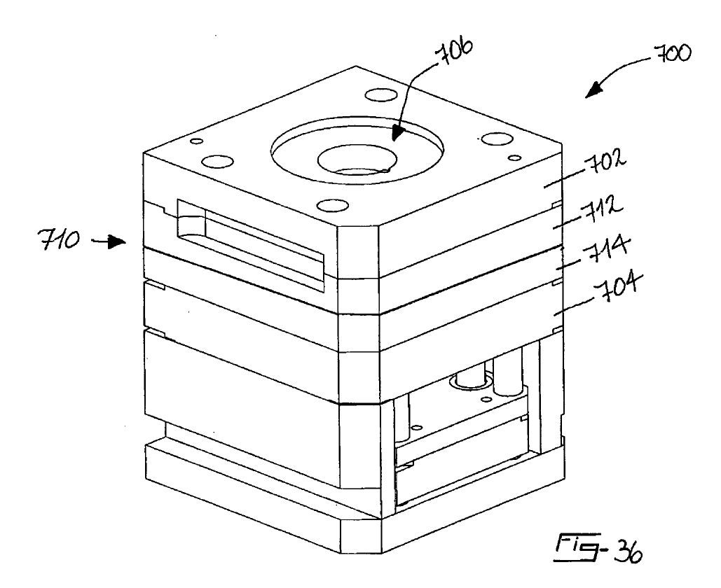

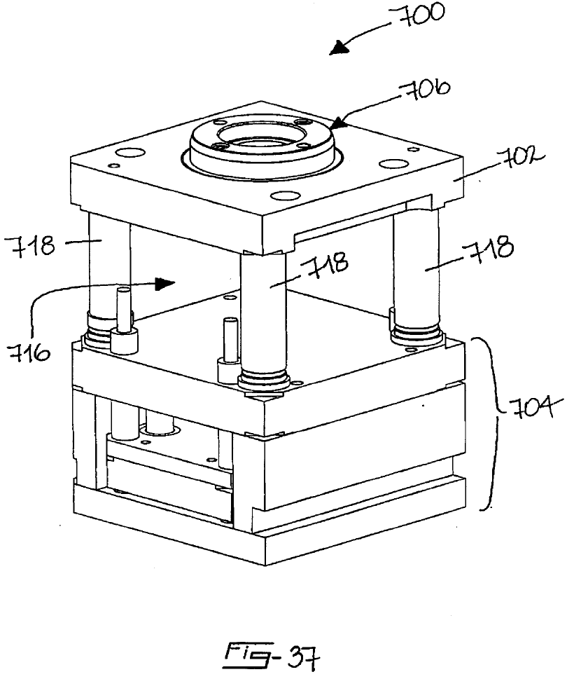

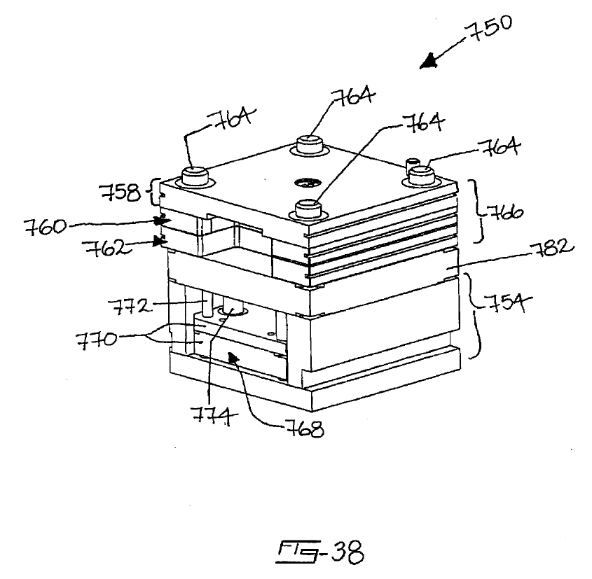

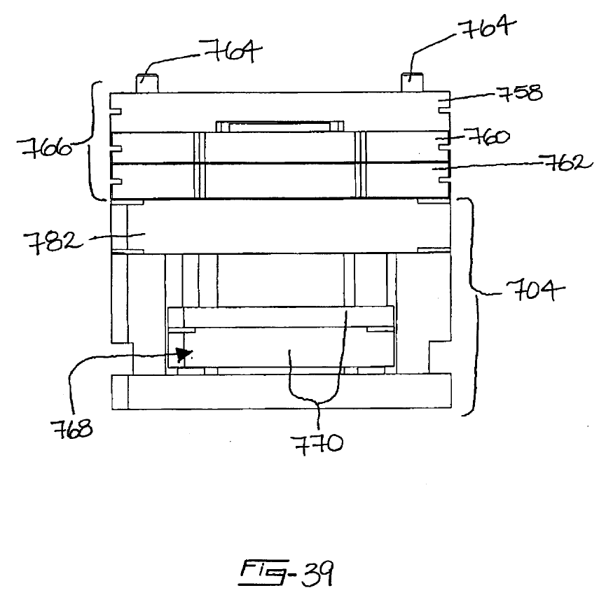

The injection plate 606 and the end plates 610 define a top molding cavity (not shown) which is interfaced with a bottom molding cavity 618 formed on the base 604, as shown in FIGS. 33 and 34

The bottom cavity 618 includes core pins 620, in this way, silicone tubings 652 (see FIG. 33) can be molded directly using these core pins 620 of a smaller diameter without the use of insert molding. After curing, each core pin 620 is removed and a longitudinal bore 654 remains in its place as shown in FIG. 33. As previously explained, the cavity 618 provides larger grooves for forming ridges 652 as well as smaller grooves to embed electrode wires 656 (see FIG. 35).

With particular reference to FIG. 34, the base 604 includes alignment pins 622 to properly position the core pins 620 and tightening screws 620 to appropriately tighten electrode wires.

### Industrial Nerve Cuff Mold (700)

With reference to FIGS. 36 and 37 an industrial nerve cuff injection mold 700 in accordance with an non-restrictive illustrative embodiment of the present invention will now be described.

The industrial mold 700 provides for a permanent liquid injection machine having first and second or top and bottom platens or bases 702 and 704. An injection unit 706 is mounted to the top base 702. A mold pattern assembly 710, including first and second or top and bottom interfaced molding bodies or plates 712 and 714, is mounted between the bases 702 an 704 which define a receiving space 716 therebetween. Inverted leader pins 718 mounted to both the top and bottom bases provide for selectively mounting a variety of mold pattern assemblies such as assembly 710. As described herein the interfaced top and bottom molding bodies 712 and 714 include respective top and bottom molding cavities (not shown) for providing a variety of molding patterns thereby providing various types of nerve cuffs.

### Industrial Nerve Cuff Mold (750)

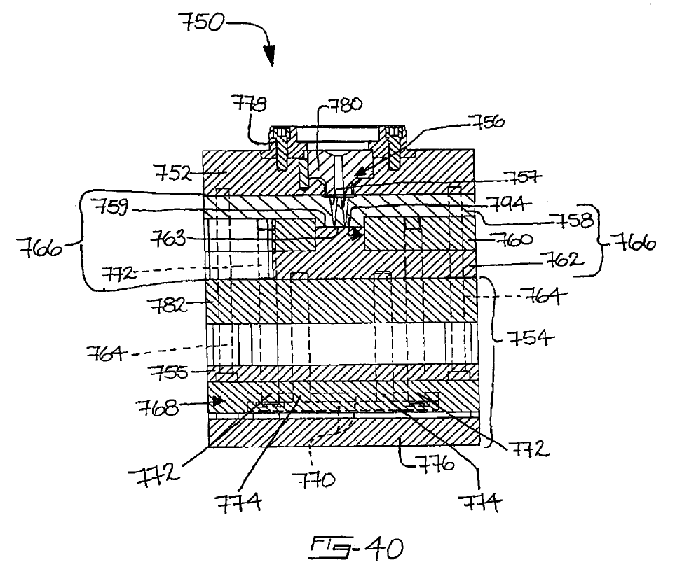

With reference to FIGS. 38 to 40, an industrial nerve cuff injection mold 750 in accordance with another non-restrictive illustrative embodiment of the present invention will now be described.

The industrial mold 750 is similar to industrial mold 700 and includes top and bottom bases 752 (see FIG. 40) and 754, respectively. An injection unit 756 (see FIG. 40) having injection nozzles 757 is mounted to the top base 752, which in turn is mounted to a top body or plate 758 defining a top cavity. A molding pattern cassette 760 is mounted between the top cavity plate 758 and a bottom body or plate 762 defining a bottom cavity. The top cavity plate 758, the cassette 760 and the bottom cavity plate 762 together define a molding pattern assembly 766.

The industrial mold 750 also includes inverted leader pins 764 mounted to a leader pin support plate 755 (see FIG. 40) that allow the top cavity 758, the cassette 760 and the bottom cavity 762 guidance without fixing these platens together (as normally done with plastic mold tools).

The industrial mold 750 further includes an ejector assembly 768. With particular reference to FIG. 40, the ejector assembly 768 includes ejector plates 770 having ejector rods 772 and 774 upstanding therefrom. Ejector rods 772 are taller than ejector rods 774 and provide for ejecting the top cavity plate 758, whereas the lower shorter ejector rods 774 provide for ejecting the cassette 760.

It should be noted that the top base 752, the bottom base 754 and the ejector assembly 768 are generic for all cuff sizes; only the top and bottom cavities 758 and 762 and the cassette 760 interposed therebetween are specific to a given cuff size and configuration.

The top base 752 is permanently fixed on the top molding plate 758 while the bottom base 754 and ejector plates 770 remain fixed on the bottom platform 776. Therefore, the top base 752 contains the top molding plate 758, a locational ring 778 and a sprue bushing 780 see FIG. 40.

In operation, the two stage process remains substantially unchanged compared to hybrid mold design. Plungers added on the first stage top cavity 758 push locally on the electrode wires. Then, the first stage top cavity plate 758 is replaced by the second top cavity plate 758 (i.e., the same configuration but without the plungers, the plungers may either be removed or a plate devoid of plungers may be used) to fill the holes created by the plungers. Indeed, the thickness of the nerve cuff after the second stage will be greater than the thickness of the cuff after the first stage since a supplemental thin layer is added along within filling any indentations or spaces.

### Cassette

The aim of the removable cassette 760 is to install the part inserts (core pins, electrode wires, tubes etc.). This is advantageous given the fact that the mold needs to be heated at a high temperature and using cassettes such as 760 allows the user to avoid waiting for the just used cassette to cool down before applying a second injection. As such, more that one cassette 760 is available for more than one injection procedures thereby saving operational time. Since the cassette 760 is removable, the operator could load the inserts gently with a magnifier or microscope on a remote table and then proceed to install the cassette within the industrial mold 750. A respective cassette 760 per cuff size and configuration is more efficient than re configuring the cassette. The cassette 760 includes clamps for holding the mold inserts in place as well as tensioning mechanism for the wires.

The removable cassette 760 needs to be secured with a clamping device between the first and second stages. Hence, the removable cassette 760 has to be maintained firmly against the bottom cavity plate 762 during replacement of the top cavity plate 758 to prevent partial or complete ejection. A Bimba™ mold lock cylinder with ballonet, to give one non-limiting example is suitable for maintaining the cassette 760 in place.

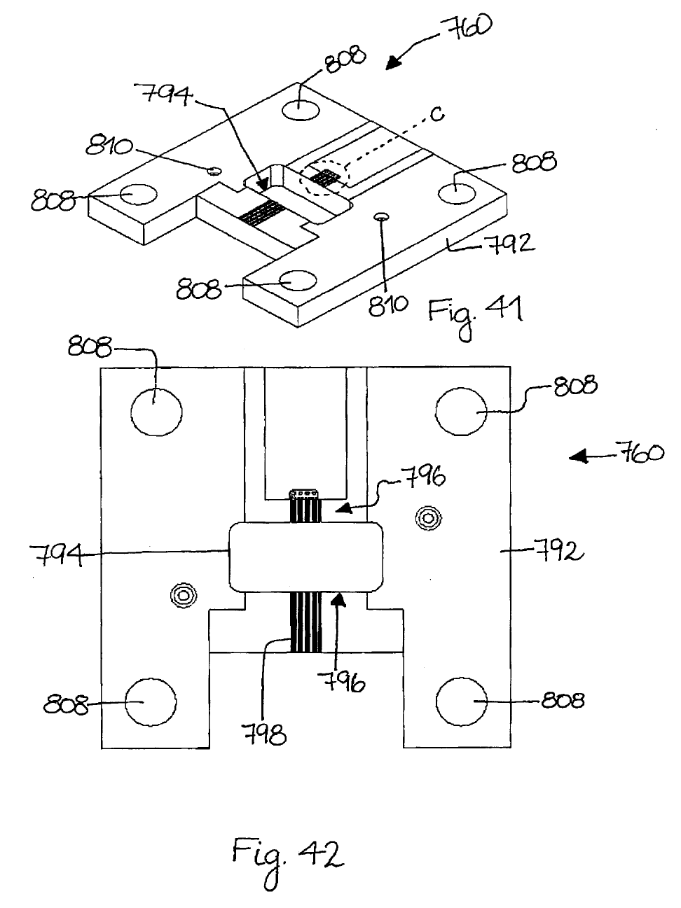

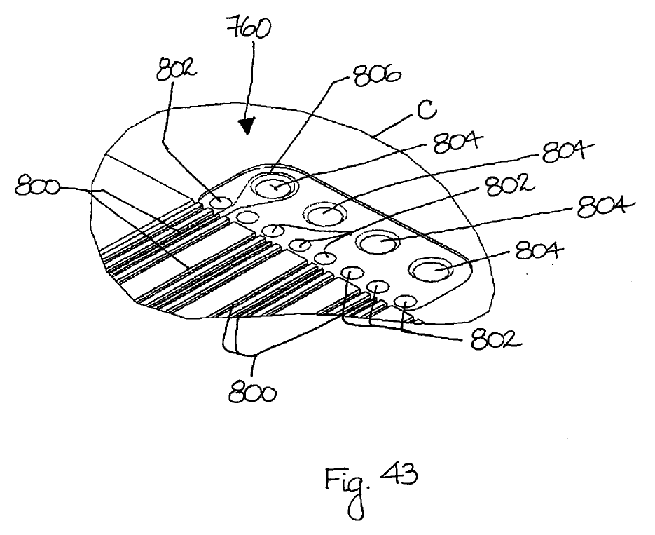

With reference to FIG. 41 to 43, the cassette 760 includes a generally flat plate body 792 having a central cavity 794. The central cavity 794 receives portions 759 and 763 of the top and bottom cavities 758 and 762 respectively (see FIG. 40) which are interfaced. Cassette sections 796 are adjacent to the cavity 794 and provide for the inserts to be contiguous with the interface junction between portion 759 and 763. The inserts include core pins 798 are positioned within longitudinal grooves 800. Alignment pins 802 provide for aligning the core pins 798 and tightening screws 804 appropriately tighten the electrode wires, such as SS wires 806. The cassette body 792 also includes holes 808 at each corner thereof for receiving the leading pins 766, as well as holes 810 for the alignment taper pins (not shown but discussed below).

### Alignment

Since mold alignment between the bottom base 754 and the cavity plates 758 and 762 is not an important factor, alignment relies exclusively on the leader pins 764 and shoulder bushings (not shown). The bottom cavity 762 is secured to a bottom base plate 782 with screws and remains there until completion of a given lot of nerve cuffs.

Alignment between the bottom cavity 762 and cassette 760 is provided via taper pins (not shown) which are inserted into the tape pin holes 810. Shoulder bushing are not added on the cassette 760.

Finally, alignment between the top and bottom cavity plates 758 and 760 provided with shoulder bushings (not shown) and side latches or locks (not shown).

Of course the skilled artisan may contemplate a variety of ways of aligning the components of the industrial mold within the context of the present invention.

### Coating and Maintenance

In one non-limiting example, the cavity plates 758 and 762 and the cassette 760 are coated with PolyOnd. The core pins may be coated as well. Due to the reduced size of the core pins, a high scrap factor should be considered. For greater resistance to corrosion of the various platens of the industrial mold 750 it is suggested to coat the components thereof with corrosion resistance coating such as ElectrolessNickel for example. It is also advisable to use greaseless bushings instead of STD bronze bushings with grease to reduce cross-linking contamination. Similarly, needle side interlocks could be beneficial in reducing wear and tear.

### Molding Sequence

The present invention also provides for a method of molding a nerve cuff, comprising the following steps:

Installing the bottom cavity on the bottom base;

Loading the inserts (e.g. core pins and SS wires) on the cassette

Positioning the cassette on the bottom cavity plate

Aligning the first stage top cavity plate (including plungers) over the cassette.

Positioning the top base on the first stage top cavity plate

Providing for the industrial mold to warm up.

Injecting the first stage silicone

Providing for the first stage silicone to cure.

Removing the top base.

Ejecting the first stage top cavity plate.

Aligning the second stage top cavity plate (without plungers) over the cassette.

Positioning the top base on the second stage top cavity plate.

Injecting the second stage silicone.

Providing for the second stage silicone to cure.

Removing the core pins thereby providing the silicone tubings.

Ejecting the second stage top cavity plate.

Removing the cassette including:
a. Unclamping the cassette by removing the air pressure from the Bimba™ actuator; and
b. Ejecting the cassette stage with ejector assembly.

The skilled artisan will readily appreciate that the various components of the various non-limiting embodiments described herein can be combined in a variety of suitable ways to provide other non-illustrated embodiments within the context of the present invention.

Although the present invention has been described by way of particular embodiments and examples thereof, it should be noted that it will be apparent to persons skilled in the art that modifications may be applied to the present particular embodiment without departing from the scope of the present invention.

1. A mold for a nerve cuff comprising:
a first molding body defining a first molding cavity; and
a second molding body defining second molding cavity, said second molding body being mountable to said first molding body for interfacing said second molding cavity with said first molding cavity during the molding procedure;
wherein when interfacing said first and second molding cavities and injecting moldable material therebetween provides the nerve cuff following curing of the moldable material.

2. The mold according to claim 1, wherein said first molding body comprises a top molding body and defines a top molding cavity and said second molding body comprises a bottom molding body defining a bottom molding cavity.

3. The mold according to claim 1, wherein at least one of said first and second molding cavities comprises longitudinal grooves.

4. The mold according to claim 3, wherein said longitudinal grooves comprise tube grooves for receiving tubes therein and wire grooves for receiving electrode wires therein.

5. The mold according to claim 3, wherein both said first and second molding cavities comprise longitudinal grooves.

6. The mold according to claim 5, wherein said respective longitudinal grooves of said first and second molding cavities are interfaced so as to provide longitudinal molding channels for receiving moldable material therein.

7. The mold according to claim 1, wherein at least one of said first and second molding cavities comprises longitudinal protuberances for being interfaced with corresponding longitudinal grooves of the other of said first and second molding cavities so as to receive molding material therebetween.

8. The mold according to claim 1, further comprising end plates mounted at each respective end of said mounted first and second molding bodies for aligning electrode wires positioned between said interfaced first and second molding cavities.

9. The mold according to claim 1, wherein at least one of said first and second molding cavities comprises plungers for holding down electrode wires positioned on the other of said first and second molding cavities.

10. The mold according to claim 9, wherein said plungers are removable.

11. The mold according to claim 1, wherein at least one of said first and second molding cavities comprises core pins for defining tubes when said first and second molding cavities are interfaced and moldable material is injected therebewteen.

12. (canceled)

13. The mold according to claim 11, wherein said core pins are removable following curing of the moldable material.

14. The mold according to claim 1, further comprising a tightness adjustment mechanism for tightening electrode wires positioned between said first and second molding cavities.

15. The mold according to claim 1, further comprising an injection unit for injecting the material between said interfaced first and second molding cavities.

16. The mold according to claim 15, wherein one of said first and second molding bodies comprises an injection plate, said injection unit mounted to said injection plate.

17. (canceled)

18. The mold according to claim 16, further comprising end plates, said injection plate being interposed between said end plates, said end plates providing for aligning electrode wires positioned between said interfaced first and second molding cavities.

19. The mold according to claim 18, wherein said end plates are mounted to the other of said first and second molding bodies.

20. The mold according to claim 1, wherein at least one of said first and second molding cavities comprises at least a portion thereof having a generally flat configuration

21. A mold for a nerve cuff comprising:
a first molding body defining a first molding cavity;
a second molding body defining second molding cavity said second molding body being mountable to said first molding body for interfacing said second molding cavity with said first molding cavity during the molding procedure; and
plungers mountable to at least one of said first and second molding cavities, said plungers holding down electrode wires positioned on the other of said first and second molding cavities when said first and second molding cavities are interfaced,
wherein when interfacing said first and second molding cavities and injecting moldable material therebetween provides the nerve cuff following curing of the moldable material.

22. The mold according to claim 21, wherein said plungers are removable from said at least one of said first and second molding cavities.

23. The mold according to claim 21, wherein said plunges comprise rectangular protuberances.

24. The mold according to claim 21, wherein the other of said first and second molding cavities having the electrode wires positioned thereon comprises grooves for receiving the electrode wires therein.

25. The mold according to claim 21, wherein at least one of said first and second molding cavities comprises at least a portion thereof having a generally flat configuration.

26. The mold according to claim 25, wherein said plungers are mountable to said generally flat portion.

27. The mold according to claim 21, wherein said first molding body comprises a top molding body and defines a top molding cavity and said second molding body comprises a bottom molding body defining a bottom molding cavity.

28. A mold for a nerve cuff comprising:
a first molding body defining a first molding cavity;
a second molding body defining second molding cavity, said second molding body being mountable to said first molding body for interfacing said second molding cavity with said first molding cavity during the molding procedure; and
core pins mounted to at least one of said first and second molding cavities,
wherein when interfacing said first and second molding cavities and injecting moldable material therebetween provides the nerve cuff following curing of the moldable material, and wherein said core pins provide for defining tubes within the nerve cuff.

29. The mold according to claim 28, wherein said core pins are aligned via alignment pins mounted to said at least one of said first and second molding cavities.

30. The mold according to claim 28, wherein at least one of said first and second molding bodies comprises tightening screws for tightening electrode wires attached thereto and positioned between said first and second molding cavities when interfaced.

31. The mold according to claim 28, wherein one of said first and second molding bodies comprises an injection plate.

32. The mold according to claim 31, further comprising an injection unit mounted to said injection plate.

33. (canceled)

34. The mold according to claim 31, wherein said injection plate is interposed between a pair of end plates for said end plates providing for aligning electrode wires positioned between said interfaced first and second molding cavities.

35. The mold according to claim 34, wherein said end plates are mounted to the other of said first and second molding bodies.

36. The mold according to claim 28, wherein said first molding body comprises a top molding body and defines a top molding cavity and said second molding body comprises a bottom molding body defining a bottom molding cavity.

37. (canceled)

38. A mold for a nerve cuff comprising:
a first base;
a second base; and
a molding pattern assembly mounted between said first and second bases;
wherein when injecting moldable material to said molding pattern assembly, said molding pattern assembly provides a nerve cuff following curing of the moldable material.

39.-43. (canceled)

44. The mold according to claim 38, wherein said molding pattern assembly further comprises a removable cassette removably mountable between said first and second molding bodies, said cassette comprising inserts, said inserts being interposed between said first and second molding cavities for providing a molding pattern to the nerve cuff, said inserts being selected from the group consisting of: core pins, electrode wires, tubes and any combination thereof.

45.-60. (canceled)
